(19) United States
(12) Patent Application Publication
(10) Pub. No.: US 2013/0054606 A1
(43) Pub. Date: Feb. 28, 2013

(54) SPATIAL PROCESSING SYSTEM, SOFTWARE AND METHOD

(71) Applicant: Richard Zimmerman, Tucson, AZ (US)

(72) Inventor: Richard Zimmerman, Tucson, AZ (US)

(73) Assignee: Intelligent Integration Systems, Inc., Boston, MA (US)

(21) Appl. No.: 13/596,008

(22) Filed: Aug. 27, 2012

Related U.S. Application Data
(60) Provisional application No. 61/528,097, filed on Aug. 26, 2011.

(51) Int. Cl. G06F 17/30

(52) U.S. Cl. 707/740; 707/736; 707/E17.046

(57) ABSTRACT

A system, software and method which enable the analysis of a spatial database.

### FIELD OF THE INVENTION

The present invention is directed generally to a system, software and method that can examine a database, online dataset or datastream and identify user-defined or user-selected patterns that are anomalous or otherwise significant (e.g., a specific shape, sets of shapes or locations not based on coordinates).

As is known to those of ordinary skill in the art, these tasks are performed by employing what are known as spatial (or geospatial) extensions by the database. Most every major database now has an extension pack for dealing with “spatial” data. However, even with these extensions, some problems faced in database manipulation are too computationally intensive even for these specialized database/extension applications.

Graphics processors (or “GPUs”) are small, high performance central processing units (“CPUs) present in most computers that drive the display, accelerating complex graphics such as those in high-end CAD applications or high-resolution, interactive computer games. GPUs are specialized CPUs unlike the general-purpose CPU typically in desktop and laptop computers. While these GPUs are not efficiently used to run word processing or spreadsheet applications, they are, however, very efficient in the parallel processing of complex graphic tasks.

For example, to generate the display in a video game, the game must rapidly calculate and create a large number of 3D polygons to simulate a video stream. A wall, for instance, would be shown as a box in 3D space. The floor would be depicted as a big rectangle. Any item used in or observed in the game would be made up of a large number of triangles, rectangles, and other higher sided polygons. The game loads all these polygons (of which there can be millions) into the graphics processor then the processor applies math to actually convert the 3D space of polygons into a 2D picture that is sent to the computer monitor. It is a highly specialized task, far too computationally intensive to be handled in the computer's general purpose CPU. Offloading the graphics computations to the GPU makes the creation of complex and high-speed graphics processing possible.

What is desired, therefore, is a system, software and method to perform spatial processing on massive databases or datasets which are too complex for standard CPUs and conventional databases. The system, software and method according to the present disclosure are a new response to the needs of this effort.

### BRIEF DESCRIPTION OF THE DRAWINGS

FIG. 1 is a simplified flow diagram depicting one embodiment of the current invention.

### DETAILED DESCRIPTION OF THE INVENTION

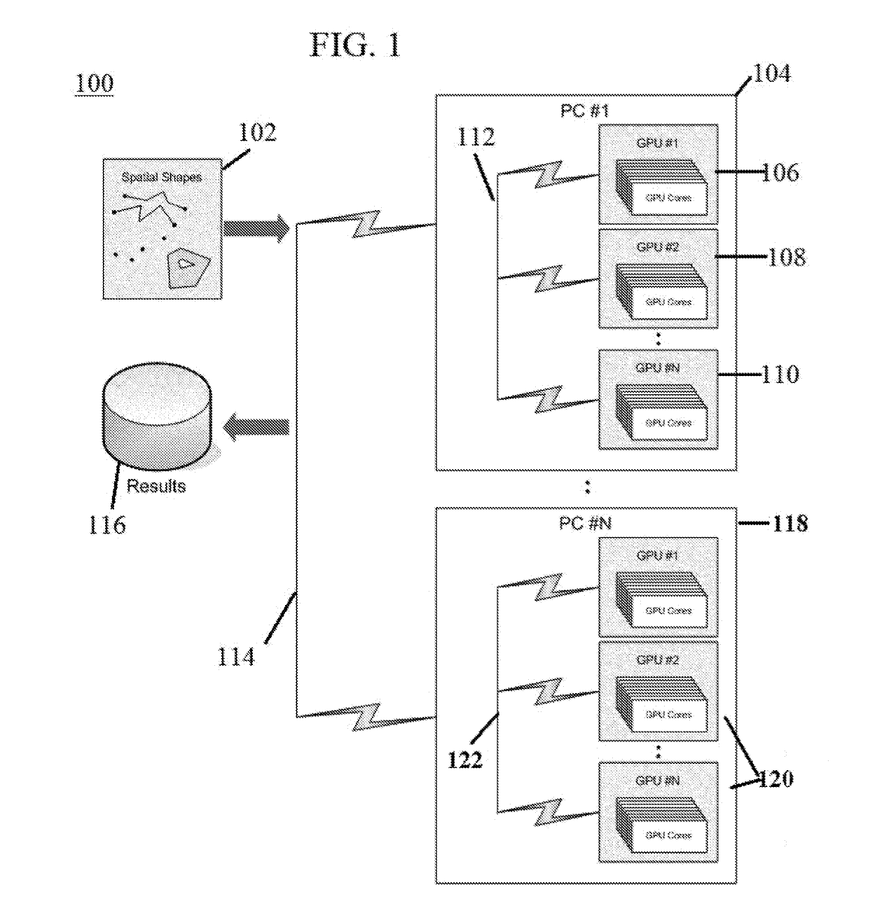

Referring now to FIG. 1, spatial figures or data 102 is provided by the user through a database, dataset, over the Internet, or through some other media or method to the spatial processing system 100. The spatial processing system 100 includes at least a first PC 104 which is further comprised of at least a first GPU 106. In another embodiment of the invention the first PC 104 further comprises at least a second GPU 108. In another embodiment of the invention the first PC 104 comprises a multiple of N GPUs 110. In one embodiment of the invention, the N multiple GPUs 106, 108, 110, are connected to a common communications protocol, network, PC bus, GPU-specific bus or some other means of coordinating at least one of multiple GPU results 112.

In one embodiment of the invention, the first PC 104 processes the spatial figures or data 102 by utilizing the computational power of the at least first GPU 106. The at least first GPU 106 processes the spatial figures and data 102 utilizing a program or subroutine.

In one embodiment of the invention, the program or subroutine that the at least first GPU 106 may consist of one, or a multiple of OpenGIS® standard-based Spatial Library subroutines. The Spatial Library may introduce a new data type such as ST_Geometry, which includes or more of the sub-types: ST_Point, ST_Curve (non-instantiatable), ST_Linestring, ST_Surface (non-instantiatable), ST_Polygon, ST_MultiCurve (non-instantiatable), ST_Multipoint, ST_MultiLineString, ST_MultiSurface (non-instantiatable), ST_MultiPolygon, or ST_GeomCollection.

In one embodiment of the invention, functions may be performed on ST_Geometry or on any of the sub-types. These functions include, without limitation:

int2=ST_Dimension(ST_Geometry input)—Returns the dimension of an ST_Geometry value. The dimension of an ST_Geometry value is less than or equal to the coordinate dimension. The return value will be one of the following:
−1 if input is an empty geometry.
0 if input corresponds to a zero-dimensional geometry.
1 if input corresponds to a one-dimensional geometry.
2 if input corresponds to a two-dimensional geometry.
   int2=ST_CoordDimension(ST_Geometry input)—Returns the coordinate dimension of an ST_Geometry value. The coordinate dimension shall be the same as the coordinate dimension of the spatial reference system for the ST_Geometry value. The return value will be one of the following:
2 for X, Y coordinate values
3 for X, Y, Z coordinate values or X, Y, M coordinate values
4 for X, Y, Z, M coordinate values.
   int2=ST_GeometryTypeCode(ST_Geometry input)—Returns the type of the parameter input as an integer value. (see Table 1 below)
   varchar=ST_GeometryType(ST_Geometry input)—Returns the type of the parameter input as a varchar value. (see Table 1 below

TABLE 1
Geometry Types

| Code | Geometry Type | Coord |
|---|---|---|
| 0 | GEOMETRY | X Y |
| 1 | POINT | X Y |
| 2 | LINESTRING | X Y |
| 3 | POLYGON | X Y |
| 4 | MULTIPOINT | X Y |
| 5 | MULTILINESTRING | X Y |
| 6 | MULTIPOLYGON | X Y |
| 7 | GEOMCOLLECTION | X Y |
| 13 | CURVE | X Y |
| 14 | SURFACE | X Y |
| 15 | POLYHEDRALSURFACE | X Y |
| 1000 | GEOMETRYZ | X Y Z |
| 1001 | POINTZ | X Y Z |
| 1002 | LINESTRINGZ | X Y Z |
| 1003 | POLYGONZ | X Y Z |
| 1004 | MULTIPOINTZ | X Y Z |
| 1005 | MULTILINESTRINGZ | X Y Z |
| 1006 | MULTIPOLYGONZ | X Y Z |
| 1007 | GEOMCOLLECTIONZ | X Y Z |
| 1013 | CURVEZ | X Y Z |
| 1014 | SURFACEZ | X Y Z |
| 1015 | POLYHEDRALSURFACEZ | X Y Z |
| 2000 | GEOMETRYM | X Y M |
| 2001 | POINTM | X Y M |
| 2002 | LINESTRINGM | X Y M |
| 2003 | POLYGONM | X Y M |
| 2004 | MULTIPOINTM | X Y M |
| 2005 | MULTILINESTRINGM | X Y M |
| 2006 | MULTIPOLYGONM | X Y M |
| 2007 | GEOMCOLLECTIONM | X Y M |
| 2013 | CURVEM | X Y M |
| 2014 | SURFACEM | X Y M |
| 2015 | POLYHEDRALSURFACEM | X Y M |
| 3000 | GEOMETRYZM | X Y Z M |
| 3001 | POINTZM | X Y Z M |
| 3002 | LINESTRINGZM | X Y Z M |
| 3003 | POLYGONZM | X Y Z M |
| 3004 | MULTIPOINTZM | X Y Z M |
| 3005 | MULTILINESTRINGZM | X Y Z M |
| 3006 | MULTIPOLYGONZM | X Y Z M |
| 3007 | GEOMCOLLECTIONZM | X Y Z M |
| 3013 | CURVEZM | X Y Z M |
| 3014 | SURFACEZM | X Y Z M |
| 3015 | POLYHEDRALSURFACEZM | X Y Z M |

int=ST_SRID(ST_Geometry input)—Returns the spatial reference system identifier of an ST_Geometry value.
ST_Geometry=ST_SRID(ST_Geometry input, int SRID)—Sets the spatial reference system identifier of a ST_Geometry value. SRIDs are provided for reference purposes and are not enforced or transformed by the system.
bool=ST_IsEmpty(ST_Geometry input)—Tests if an ST_Geometry value corresponds to the empty set.
bool=ST_IsSimple(ST_Geometry input)—Tests if an ST_Geometry value has no anomalous geometric point, such as self intersection or self tangency. Subtypes of ST_Geometry will define the specific conditions that cause a value to be classified as simple.
bool=ST_IsSpatial(varchar input)—Tests if a varchar field is a valid spatial argument.
bool=ST_Is3D(ST_Geometry input)—Tests whether an ST_Geometry value has a Z dimension.
bool=ST_IsMeasured(ST_Geometry input)—Tests whether an ST_Geometry value has measures (the M dimension).
ST_Geometry=ST_LocateAlong(ST_Geometry input, double m1)—Returns a geometry representing points that have the specified measure value. Result can be either an ST_MultiPoint, an ST_MultiLineString or a ST_GeometryCollection (with just points and linestrings), depending on the input and the value of m1.
ST_Geometry=ST_LocateBetween(ST_Geometry input, double fm, double tm)—Returns a value representing points or paths that have measures in the specified range. Result can be either an ST_MultiPoint, an ST_MultiLineString or a ST_GeometryCollection (with just points and linestrings), depending on the input and the values of fm and tm.
ST_Geometry=ST_Boundary(ST_Geometry input)—Returns the boundary of a ST_Geometry value.
ST_Polygon=ST_Envelope(ST_Geometry input)—Returns the bounding rectangle of a ST_Geometry value. ST_Envelope( ) always returns an ST_Polygon. In the degenerate cases when the bounding rectangle consists of only a single point or a horizontal or vertical line, the returned rectangle will be slightly buffered in order to ensure that it is still a valid ST_Polygon value.
ST_Geometry=ST_MBR(ST_Geometry input)—Returns the minimum bounding rectangle of a ST_Geometry value. ST_MBR( ) will generally return a ST_Polygon, but will return an ST_Point if the MBR consists of only a single point or an ST_LineString if the MBR consists of a single horizontal or vertical line.
ST_Geometry=ST_Expand(ST_Geometry input, double adistance)—Returns the minimum bounding rectangle of a ST_Geometry value expanded out by the adistance parameter. ST_Expand( )will generally return a ST_Polygon, but will return an ST_Point if the resulting rectangle consists of only a single point or an ST_LineString if the resulting rectangle consists of a single horizontal or vertical line.
ST_Geometry=ST_Expand_Sphere(ST_Geometry input, double adistance, [varchar units])—Returns the minimum bounding rectangle of a ST_Geometry value expanded out by the adistance parameter. Geometric objects are expected to be specified in terms of latitude/longitude on a spherical earth model. This function will return values in the specified units (see Appendix A for a list of supported units). If no units are given, the result is returned in meters. ST_Expand Sphere( ) will generally return a ST_Polygon, but will return an ST_Point if the resulting rectangle consists of only a single point or an ST_LineString if the resulting rectangle consists of a single horizontal or vertical line.
ST_Geometry=ST_Expand_WGS84(ST_Geometry input, double adistance[, varchar units])—Returns the minimum bounding rectangle of a ST_Geometry value expanded out by the adistance parameter. Geometric objects are expected to be specified in terms of latitude/longitude on a WGS84 earth model. This function will return values in the specified units (see Appendix A for a list of supported units). If no units are given, the result is returned in meters. ST_Expand WGS840 will generally return a ST_Polygon, but will return an ST_Point if the resulting rectangle consists of only a single point or an ST_LineString if the resulting rectangle consists of a single horizontal or vertical line.
ST_Geometry=ST_ConvexHull(ST_Geometry input)—Returns the convex hull of an ST_Geometry value.
ST_Geometry=ST_Buffer(ST_Geometry input, double adistance)—Returns the ST_Geometry value that represents all points whose distance from any point of an ST_Geometry value is less than or equal to a specified distance. Distance may be a negative number.
ST_Geometry=ST_Intersection(ST_Geometry inputa, ST_Geometry inputb)—Returns the ST_Geometry value that represents the point set intersection of two ST_Geometry values.
ST_Geometry=ST_Union(ST_Geometry inputa, ST_Geometry inputb)—Returns the ST_Geometry value that represents the point set union of two ST_Geometry values.
ST_Geometry=ST_Difference(ST_Geometry inputa, ST_Geometry inputb)—Returns the ST_Geometry value that represents the point set difference of two ST_Geometry values.
ST_Geometry=ST_SymDifference(ST_Geometry inputa, ST_Geometry inputb)—Returns the ST_Geometry value that represents the point set symmetric difference of two ST_Geometry values. (otherwise known as the Exclusive OR)—Returns the minimum shortest distance between any two points in the two ST_Geometry values
double=ST_Distance_Sphere(ST_Geometry inputa, ST_Geometry inputb[, varchar units])—Returns the minimum shortest distance between any two points in the two ST_Geometry values. Objects are expected to be specified in terms of latitude/longitude on a spherical earth model. Will return values in the specified supported units. If no units are given, the result is returned in meters.
double=ST_Distance_WGS84(ST_Geometry inputa, ST_Geometry inputb[, varchar units])—Returns the minimum shortest distance between any two points in the two ST_Geometry values. Objects are expected to be specified in terms of latitude/longitude on a WGS84 Ellipsoid earth model. Will return values in the specified supported units. If no units are given, the result is returned in meters. This returns much more precise results than ST_Distance_Sphere( ).
ST_Geometry=ST_WKTToSQL(varchar input[, int srid])—Converts the input WKT varchar into the ST_Geometry equivalent. A spatial reference system identifier can be optionally specified.
ST_Geometry=ST_WKBToSQL(varchar input[, int srid])—Converts the input WKB varchar into the ST_Geometry equivalent. A spatial reference system identifier can be optionally specified.
ST_Geometry=ST_WKBLoader(varchar input, int flags)—Converts the input WKB varchar into the ST_Geometry equivalent. The flags parameter controls how the geometries are parsed and loaded. The supported values for flags are:
0x02—Null for non-simple geometries—In the event that a non-simple geometry is passed to the function, null will be returned instead of a “Geometry is not Simple” exception being thrown.
varchar=ST_AsText(ST_Geometry input)—Converts the input ST_Geometry object into the WKT equivalent.
varchar=ST_AsBinary(ST_Geometry input)—Converts the input ST_Geometry object into the WKB equivalent.
varchar=ST_AsKML(ST_Geometry input[, varchar extra_tags])—Converts the input ST_Geometry object into the KML equivalent. The extra_tags field is used to include extra KML tags into the KML object wrapper.
bool=ST_Equals(ST_Geometry inputa, ST_Geometry inputb)—Tests if an ST_Geometry value is spatially equal to another ST_Geometry value.
bool=ST_Disjoint(ST_Geometry inputa, ST_Geometry inputb)—Tests if an ST_Geometry value is spatially disjoint from another ST_Geometry value.
bool=ST_Intersects(ST_Geometry inputa, ST_Geometry inputb)—Tests if an ST_Geometry value spatially intersects another ST_Geometry value
bool=ST_Touches(ST_Geometry inputa, ST_Geometry inputb)—Tests if an ST_Geometry value spatially touches another ST_Geometry value.
bool=ST_Crosses(ST_Geometry inputa, ST_Geometry inputb)—Tests if an ST_Geometry value spatially crosses another ST_Geometry value.
bool=ST_Within(ST_Geometry inputa, ST_Geometry inputb)—Tests if an ST_Geometry value is spatially within another ST_Geometry value.
bool=ST_Contains(ST_Geometry inputa, ST_Geometry inputb)—Tests if an ST_Geometry value spatially contains another ST_Geometry value.
bool=ST_Overlaps(ST_Geometry inputa, ST_Geometry inputb)—Tests if an ST_Geometry value spatially overlaps another ST_Geometry value.
bool=ST_EnvIntersects(ST_Geometry inputa, ST_Geometry inputb)—Tests if the envelope of one geometry intersects that of another. This function is a faster execution equivalent of ST_Intersects(ST_MBR(inputa), ST_MBR(inputb)).
bool=ST_Relate(ST_Geometry inputa, ST_Geometry inputb, char[9] matrix)—Tests if an ST_Geometry value is spatially related to another ST_Geometry value by testing for intersections between the interior, boundary and exterior of the two ST_Geometry values as specified by the intersection matrix.
bool=ST_DWithin(ST_Geometry inputa, ST_Geometry inputb, double distance)—Returns true if geometry inputa is within the specified distance of geometry inputb. This is a faster execution equivalent to ST_Distance(inputa, inputb)<distance.
bool=ST_DWithin_Sphere(ST_Geometry inputa, ST_Geometry inputb, double distance [, varchar units])—Returns true if geometry inputa is within the specified distance of geometry inputb. Equivalent to ST_Distance Sphere(inputa, inputb, units)<distance, but runs significantly faster. Objects are expected to be specified in terms of latitude/longitude on a spherical earth model. Use the units optional parameter to specify the unit measure of distance. If no units are given, distance is assumed to be in meters.
bool=ST_DWithin_WGS84(ST_Geometry inputa, ST_Geometry inputb, double distance[, varchar units])—Returns true if geometry inputa is within the specified distance of geometry inputb. Equivalent to ST_Distance WGS84(inputa, inputb, units)<distance, but runs significantly faster. Objects are expected to be specified in terms of latitude/longitude on a WGS84 Ellipsoid earth model. Use the units optional parameter to specify the unit measure of distance. If no units are given, distance is assumed to be in meters. This function is much more precise than ST_DWithin_Sphere( ) (down to the centimeter), but it is also much slower.
double=ST_MinX(ST_Geometry input)—Returns the minimum X ordinate of the input geometry. Returns null if the input is null or if the input is empty.
double=ST_MaxX(ST_Geometry input)—Returns the maximum X ordinate of the input geometry. Returns null if the input is null or if the input is empty.
double=ST_MinY(ST_Geometry input)—Returns the minimum Y ordinate of the input geometry. Returns null if the input is null or if the input is empty.
double=ST_MaxY(ST_Geometry input)—Returns the maximum Y ordinate of the input geometry. Returns null if the input is null or if the input is empty.
double=ST_MinZ(ST_Geometry input)—Returns the minimum Z ordinate of the input geometry. Returns null if the input is null, if the input is empty, or if the input has no Z ordinate.
double=ST_MaxZ(ST_Geometry input)—Returns the maximum Z ordinate of the input geometry. Returns null if the input is null, if the input is empty, or if the input has no Z ordinate.
double=ST_MinM(ST_Geometry input)—Returns the minimum Measure ordinate of the input geometry. Returns null if the input is null, if the input is empty, or if the input has no Z ordinate.
double=ST_MaxM(ST_Geometry input)—Returns the maximum Measure ordinate of the input geometry. Returns null if the input is null, if the input is empty, or if the input has no Measure ordinate.

### Aggregate Functions

In one embodiment of the invention, in addition to the above referenced functions and subroutines, there are additional aggregate functions and subroutines which can be universally applied to all of the sub-types that derive from the ST_Geometry type. These aggregate functions include the following:

ST_Geometry=ST_MBRAggr(set ST_Geometry input)—Returns the minimum bounding rectangle of a set of ST_Geometry values. ST_MBRAggr( ) will generally return a ST_Polygon, but will return an ST_Point if the MBR consists of only a single point or an ST_LineString if the MBR consists of a single horizontal or vertical line.
ST_Polygon=ST_EnvelopeAggr(set ST_Geometry input)—Returns the envelope that encompasses all the input geometries. This function always results in a ST_Polygon for non-null inputs. This function will slightly buffer the actual minimum bounding rectangle if it would result in an ST_LineString or ST_Point object.

### Sub-Type Functions

In one embodiment of the invention, multiple functions may be performed on the ST_Geometry sub-types, such as:

### Functions on ST_Point Type

ST_Point=ST_Point(double x, double y [, double z] [, int srid])
ST_Point=ST_PointM(double x, double y [, double z], double m[, int srid])—Constructs a point object from the specified values. Optionally a z parameter and a spatial reference system ID can be specified.
double=ST_X(ST_Point input)—Returns the corresponding dimension of the input.
double=ST_Y(ST_Point input)—Returns the corresponding dimension of the input.
double=ST_Z(ST_Point input)—Returns the corresponding dimension of the input.
double=ST_M(ST_Point input)—Returns the corresponding dimension of the input.
ST_Point=ST_X(ST_Point input, double x)—Updates the specified dimension of the ST_Point object.
ST_Point=ST_Y(ST_Point input, double y)—Updates the specified dimension of the ST_Point object.
ST_Point=ST_Z(ST_Point input, double z)—Updates the specified dimension of the ST_Point object.
ST_Point=ST_M(ST_Point input, double m)—Updates the specified dimension of the ST_Point object.

### Functions on ST_LineString Type

ST_Point=ST_StartPoint(ST_LineString input)
ST_Point=ST_EndPoint(ST_LineString input)
bool=ST_IsRing(ST_LineString input)
bool=ST_IsClosed(ST_LineString input)
double=ST_Length(ST_LineString input)
double=ST_Length_Sphere(ST_LineString input [, varchar units])
double=ST_Length_WGS84(ST_LineString input [, varchar units])
integer=ST_NumPoints(ST_LineString input)
ST_Point=ST_PointN(ST_LineString input, integer n)

### Functions on ST_Surface Type

double=ST_Area(ST_Surface input)
double=ST_Perimeter(ST_Surface input)
double=ST_Perimeter_Sphere(ST_Surface input[, varchar units])
double=ST_Perimeter_WGS84(ST_Surface input[, varchar units])
ST_Point=ST_Centroid(ST_Surface input)
ST_Point=ST_PointOnSurface(ST_Surface input)

### Functions on ST_Polygon Type

Functions of type ST_Polygon support all the functions listed for type ST_Surface in addition to the following:

integer=ST_NumInteriorRing(ST_Polygon input)
ST_LineString=ST_ExteriorRing(ST_Polygon input)
ST_LineString=ST_InteriorRingN(ST_Polygon input, integer n

### Functions on ST_GeomCollection Type

integer=ST_NumGeometries(ST_GeomCollection input);
ST_Geometry=ST_GeometryN(ST_GeomCollection input, integer n)

### Functions on ST_Multipoint Type

Functions of type ST_MultiPoint support all the functions for ST_GeomCollection and ST_Geometry type.

### Functions on ST_MultiLineString Type

Functions of type ST_MultiLineString support all the functions for the ST_GeomCollection in addition to the following:

bool=ST_IsRing(ST_LineString input)
bool=ST_IsClosed(ST_LineString input)
double=ST_Length(ST_LineString input)
double=ST_Length_Sphere(ST_LineString input [, varchar units])
double=ST_Length_WGS84(ST_LineString input [, varchar units])

### Functions on ST_MultiPolygon Type

Functions of type ST_MultiPolygon support all the methods of type ST_GeomCollection in addition to the following:

double=ST_Area(ST_MultiSurface input)
ST_Point=ST_Centroid(ST_MultiSurface input)
ST_Point=ST_PointOnSurface(ST_MultiSurface input)

The result 116 may be delivered to the user directly, over a network 114, or over the Internet.

In another embodiment of the present invention, a multiple of N PCs 118 comprised of a multiple of N GPUs 120 connected by a common bus 122 may perform one or more of the same functions as outlined above.

In another embodiment of the present invention, a multiple of N GPUs 120 may be contained on a single computer expansion card.

In another embodiment of the present invention, a multiple of N GPUs 120 may be configured as an embedded system.

In another embodiment of the present invention, a multiple of N GPUs 120 may be configured on a single chip.

In one embodiment of the invention, the above listed subroutines and programs may be presented to the end-user as a stand-alone spatial library.

In one embodiment of the invention, the above listed subroutines and programs may be presented to the end-user as a stand-alone database.

In one embodiment of the invention, the above listed subroutines and programs may be presented to the end-user as an extension, add-on, add-in or connection to an existing database management software or system.

In one embodiment of the invention, the above listed subroutines and programs may be presented to the end-user as an event processing system. In this embodiment, the database may be particularly optimized for dealing with streaming data. An example of streaming data would be a particular stock ticker, or news feed. Event processors are typically used to spot trends, or identify meaningful events within a stream of unmeaningful events.

While various embodiments of the disclosed system, software, and method have been described above, it should be understood that they have been presented by way of example only, and should not limit the claimed invention. Likewise, the various diagrams may depict an example architectural or other configuration for the disclosed system, software, and method. This is done to aid in understanding the features and functionality that can be included in the disclosed system, software, and method. The claimed invention is not restricted to the illustrated example architectures or configurations, rather the desired features can be implemented using a variety of alternative architectures and configurations. Indeed, it will be apparent to one of skill in the art how alternative functional, logical or physical partitioning and configurations can be implemented to implement the desired features of the disclosed system, software, and method. Also, a multitude of different constituent module names other than those depicted herein can be applied to the various partitions. Additionally, with regard to flow diagrams, operational descriptions and system or method claims, the order in which the steps are presented herein shall not mandate that various embodiments be implemented to perform the recited functionality in the same order unless the context dictates otherwise.

Although the disclosed system, software, and method is described above in terms of various exemplary embodiments and implementations, it should be understood that the various features, aspects and functionality described in one or more of the individual embodiments are not limited in their applicability to the particular embodiment with which they are described. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A spatial processing system for an examination of data, the system comprising: at least a first computational device including at least a first graphics processing unit, at least a first program, a spatial data set and a spatial data input means wherein the first computational device processes the spatial data using the computational power of the first graphics processing unit utilizing the first program and producing a report configured to correspond to analysis of the spatial data of at least a first program output.

2. A spatial processing system according to claim 1 wherein the at least a first computational device further comprises a joined network of multiple computational devices.

3. A spatial processing system according to claim 1 wherein the joined network of multiple computational devices further comprises a joined network of multiple graphics processing units.

4. A spatial processing system according to claim 1 wherein the joined network of multiple graphics processing units are configured on a single chip.

5. A spatial processing system according to claim 1 wherein the at least a first program further comprises analysis based on at least one of a multiple of OpenGIS® standard-based Spatial Library subroutines.

6. A spatial processing system according to claim 5 wherein the at least one of a multiple of an OpenGIS® standard-based Spatial Library subroutines further comprises two or more OpenGIS® standard-based Spatial Library subroutines.

7. A software product, comprising a non-transitory computational device-readable medium in which program instructions are stored, which instructions, when read by at least a first computational device, cause the computational device to receive spatial data, process the spatial data using at least a first graphics processing unit and at least a first stored sub-routine and produce a report configured to the at least first stored sub-routine outputs.

8. The software product of claim 7 wherein the at least a first graphics processing unit further comprises two or more graphics processing units.

9. The software product of claim 7 wherein the at least a first graphics processing unit further comprises a graphics processing unit configured as an embedded system.

10. The software product of claim 7 wherein the at least a first graphics processing unit further comprises a graphics processing unit configured on a single chip.

11. The software product of claim 7 wherein the at least a first stored sub-routine further comprises two or more stored sub-routines.

12. The software product of claim 7 wherein the at least a first stored sub-routine further comprises at least one of a multiple of OpenGIS® standard-based Spatial Library subroutines.

13. The software product of claim 7 wherein the at least one of a multiple of OpenGIS® standard-based Spatial Library subroutines further comprises two or more OpenGIS® standard-based Spatial Library subroutines.

14. A method for conducting an examination of spatial data, comprising the steps of:
providing spatial data in an accessible computational device-readable format;
providing software configured to analyze at least one of a multiple of different characteristics of the spatial data and to identify at least one relationship among the at least one characteristics of the spatial data;
categorizing the spatial data into at least one user-defined category;
loading at least one output format defining at least one user-defined spatial data analysis attribute to indicate at least one characteristics of the spatial data into the software;
analyzing the spatial data based on the at least one user-defined analysis attribute;
identifying at least one relationship among the at least one characteristics of the spatial data; and
generating an at least one summary report pulled from the spatial data, wherein at least one of the providing, categorizing, loading, analyzing, identifying and generating steps is effected using a computer.

15. The method according to claim 14, further comprising the step of automatically generating a report of the at least one relationship among the at least one characteristics of the spatial data.

16. The method according to claim 44, wherein the software is online analytical processing software.

17. The method according to claim 14, wherein at least one of the providing, categorizing, loading, analyzing, identifying and generating steps is effected using cloud resources.

18. The method of claim 14, wherein the at least one of the providing, categorizing, loading, analyzing, identifying and generating steps is effected using multiple computers.

19. The method of claim 14, wherein the at least one of the providing, categorizing, loading, analyzing, identifying and generating steps is effected using an embedded system.

20. The method of claim 14, wherein the at least one of the providing, categorizing, loading, analyzing, identifying and generating steps is effected using a system on a chip.
